(19) United States
(12) Patent Application Publication
(10) Pub. No.: US 2016/0211932 A1
(43) Pub. Date: Jul. 21, 2016

(54) METHOD FOR SETTING DIFFERENT TUNER AND HMI SETTINGS

(71) Applicant: Harman Becker Automotive Systems GmbH, Karlsbad (DE)

(72) Inventors: Philipp Schmauderer, Hofen (DE); Christoph Benz, Ohlsbach (DE); Dominik Gammert, Neulingen (DE); Matthias Boetcher, Neulingen (DE)

(21) Appl. No.: 14/997,732

(22) Filed: Jan. 18, 2016

(30) Foreign Application Priority Data
Jan. 19, 2015 (EP) 15151637.4

(51) Int. Cl. H04H 40/45; H04H 20/88; H04H 20/71; H04W 4/04; H04H 20/57

(52) U.S. Cl. CPC H04H 40/45; H04W 4/046; H04H 20/57; H04H 20/71; H04H 20/88

(57) ABSTRACT

A method for setting different tuner and human machine interface, HMI, settings of a radio tuner with RDS functionality, comprising evaluating the at least one RDS signal of a broadcast received by the radio tuner; determining current country and/or current region in accordance with the at least one RDS signal; adjusting tuner settings of the radio tuner in accordance with the determined current country and/or current region; and updating the HMI settings of the radio tuner in accordance with the current country and/or current region.

### CROSS REFERENCE TO RELATED APPLICATIONS

The present application claims priority to European Patent Application No. EP15151637.4, entitled “METHOD FOR SETTING DIFFERENT TUNER AND HMI SETTINGS,” and filed on Jan. 19, 2015, the entire contents of which are hereby incorporated by reference for all purposes.

### FIELD

The present disclosure relates to method for setting different tuner and HMI settings for a radio receiver, such as a receiver of a car radio in a vehicle or a portable receiver.

### BACKGROUND

Nowadays vehicles, in particular, automobiles, are usually equipped with car radios. While these units may combine many more functions such as infotainment systems, telematic systems, vehicle-to-vehicle and in vehicle-to-infrastructure systems, support and emergency system, integrated hands-free cell phones, wireless safety communications, automatic driving assistance systems, mobile data, etc., the FM radio function still plays a significant and important role in such systems. FM broadcasting is a VHF broadcasting technology which uses frequency modulation, FM, to provide high-fidelity sound over broadcast radio. According to the International Telecommunication Union, ITU, the term VHF designates the range of radio frequency electromagnetic waves from 30 MHz to 300 MHz. In the following, the description will mostly refer to FM car radio and/or portable FM radios, knowing that such a radio may be combined with a plurality of the other elements mentioned above. In the following, any mentioning of a car radio and/or portable FM radio should in particular include a FM car radio and FM portable radio. In the following, the terms (radio) tuner and (radio) receiver are used synonymously, as only the radio tuning aspect is concerned, not the amplification or audio/sound aspect.

Many modern FM radios, in particular car radios, to at least some extent use the Radio Data System, RDS. RDS represents a communications protocol standard for embedding small amounts of digital information in conventional FM radio broadcasts. RDS usually is intended for application for VHF/FM sound broadcasts in the frequency range of 87.5 MHz to 108.0 MHz, which may carry either stereophonic, pilot-tone system, or monophonic programs. RDS typically aims at providing improved functionality for FM tuners/receivers such as program identification, program service name display, and possibly automatic tuning for portable and car radios. Radio Broadcast Data System, RBDS, is the official name used for the U.S. version (North America version) of RDS, whereas the two standards are only slightly different. In the following, the abbreviation RDS should encompass also RBDS, if not explicitly noted otherwise.

RDS as well as RBDS carry data at 1,187.5 bits per second on a 57-kHz subcarrier, such that there are exactly 48 cycles of subcarrier during every data bit. The RBDS/RDS subcarrier is set to the third harmonic of the 19-kHz FM stereo pilot tone to minimize interference and intermodulation between the data signal, the stereo pilot, and the 38-kHz DSB-SC stereo difference signal. The stereo difference signal extends up to 38 kHz+15 kHz=53 kHz, leaving 4 kHz for the lower sideband of the RDS signal. Double-sideband suppressed-carrier transmission, DSB-SC, is a transmission in which frequencies produced by amplitude modulation are symmetrically spaced above and below the carrier frequency and the carrier level is reduced to the lowest practical level, ideally being completely suppressed.

The RDS data are sent with error correction. RDS defines many features including how private, e.g., in-house, or other undefined features which may be “packaged” in unused program groups. RDS standardizes several types of information transmitted, including time, station identification, and program information.

The following is a non-exhaustive list of information fields which are normally contained in the RDS data:

AF (Alternative Frequencies)

This allows a receiver to re-tune to a different frequency providing the same station when the first signal becomes too weak, e.g. when moving out of range. This is often utilized in car stereo systems.

CT (Clock Time)

This may be used for synchronizing a clock in the receiver or the main clock in a car. Due to transmission uncertainties, CT may only be accurate to within 100 ms of UTC. Also, not all programs may transmit CT information.

EON (Enhanced Other Networks)

This information allows the receiver to monitor other networks or stations for traffic programs, and automatically temporarily tune into that station.

PI (Program Identification)

This is the unique code that identifies the station. Every station receives a specific code with a country prefix. Where the RBDS is applied, the PI code is determined by applying a formula to the station's call sign. The PI code consists of 16 bits and is usually referred to by four hexadecimal characters, or nibbles. The PI code uniquely identifies a program service, within a particular geographical area, where broadcasts sharing the same PI code are guaranteed to be carrying identical program audio. Although there are many designs possible for an RDS receiver, evaluation of the PI code is fundamental to operation. In any receiver with preset memories, it is essential for the PI code of the broadcast to be stored in nonvolatile memory when a service is assigned to a memory location. If no signal with the correct PI code is available, on the last tuned frequency or AFs, when a preset is chosen, the receiver should scan the FM band, stop on each receivable RDS service and evaluate the PI code. The PI code is a hexadecimal code which as such usually is not displayed by the tuner/receiver.

PS (Program Service)

This refers to an eight-character static display that represents the call letters or station identity name. Most RDS capable receivers display this information and, if the station is stored in the receiver's presets, will cache this information with the frequency and other details associated with that preset.

PTY (Program Type)

This coding of up to 31 pre-defined program types (e.g., in Europe: PTY1 News, PTY6 Drama, PTY11 Rock music) allows users to find similar programming by genre. PTY31 appears to be reserved for emergency announcements in the event of natural disasters or other major calamities.

REG (Regional)

This information is mainly used in countries where national broadcasters run “region-specific” programming such as regional opt-outs on some of their transmitters. This functionality allows the user to “lock-down” the set to their current region or let the radio tune into other region-specific programming as they move into the other region.

RT (Radio Text)

This function allows a radio station to transmit a 64-character free-form text that can be either static, such as station slogans, or in sync with the programming, such as the title and artist of the currently playing broadcast or song.

TA, TP (Traffic Announcement, Traffic Program)

The receiver can often be set to pay special attention to this flag and, for example, stop the tape/pause the CD or retune to receive a traffic bulletin. The TP flag is used to allow the user to find only those stations that regularly broadcast traffic bulletins whereas the TA flag is used to signal an actual traffic bulletin in progress, with radio units perhaps performing other actions such as stopping a cassette tape (so the radio can be heard) or raising the volume during the traffic bulletin.

TMC (Traffic Message Channel)

TMC refers to digitally encoded traffic information. Not all RDS equipment supports this information, but it is often available for automotive navigation systems. In many countries only encrypted traffic data is broadcast, and so an appropriate decoder, possibly tied to a subscription service, is required to use the traffic data.

### SUMMARY

As far as implementation is concerned, most car radios support at least AF, EON, REG, PS, and TA/TP. More expensive car stereos may also offer TMC, RT, and/or PTY. Home systems, especially hi-fi receivers, may mainly support functions like PS, RT, and PTY.

Ideally, the user of an FM radio with RDS would be able to choose a program with RDS service once and then not need to re-tune his/her equipment. The AF function of the RDS is usually activated by default. The receiver may have a list of alternative frequencies of various broadcast transmitters broadcasting the same program in the current or adjacent reception areas, and enable receivers equipped with a memory to store the list, to reduce the time for switching to another transmitter. This facility is particularly useful in the case of car and portable radios. Additionally or alternatively, the user may be offered a list of different programs the receiver detects. These are programs which carry RDS information. Via a human machine interface, HMI, the user/driver may select the program he/she would like to follow. Again, the receiver may then use the AF function to follow the broadcast while the driver with her/his vehicle is moving from one reception area into another.

In practice, however, problems for modern FM receiver may arise with regard to the tuner settings of said receivers. Problems may in particular arise in that the broadcast transmitters broadcasting the radio programs may not necessarily fully comply with the FM specifications. The FM specifications, in principle, are given in the RECOMMENDATION ITU-R BS.450-3FM. In practice, however, each country of a continent, e.g., Europe, may have different parameters for their broadcast transmitters. These parameters, country by country, may often differ from the above mentioned recommendations. Whereas originally the FM broadcasting grid, e.g., the channel spacing, amounted to 300 kHz-400 kHz, this has been given up in many countries. Most countries today use a channel spacing of 100 kHz. Few countries use a channel spacing of 200 kHz, however some other countries use a channel spacing of only 50 kHz. In particular, the use of a 50 kHz grid (in general a finer grid), instead of a 100 kHz grid (a coarser standard grid) may give rise to problems, when, e.g., a vehicle passes from one region to another or one country to another and faces a change of the grid, given that the receiver is set up such that it adapts to a 100 kHz grid. This then may result in, for example, problems to tune into programs being 50 kHz off from the 100 kHz grid. A user/driver in his/her car may then encounter the problem of not being able to receive programs he might otherwise be able to receive, albeit often distorted, using an old transistor radio equipment in the respective country.

Another example may be that in some countries broadcast transmitters use a frequency deviation, e.g., modulation around the base carrier frequency, which exceeds the maximum frequency deviation specified in the recommendations. The maximum frequency deviation is specified as ±75 kHz or ±50 kHz, wherein in West European countries and the United States of America, the maximum deviation is ±75 kHz, whereas in countries of the former USSR and in some other European countries, the maximum deviation is ±50 kHz. One motivation for using a high frequency deviation may be to make programs louder. For the user of a car radio receiver, a higher frequency deviation may result in disturbing, e.g., leaking power into neighboring channels but may also result in sound problems. This may be particularly a problem in regions where countries border each other and the radio receivers may face many channels with different maximum deviations.

Still other problems may be for reception in an area with many regional programs, even if respecting recommended maximum frequency deviations. Many adjacent channels may occur and influence reception in a negative way. This may result in crosstalk from two different radio transmitters using—at least almost—the same frequency. In many populated areas, there just is not much room or not much room left in the radio spectrum. Stations may be very closely located to each other, sometimes to the point that one may hear several stations on the same frequency, at once.

In view of the above, so far it appears very difficult if not impossible to consider every broadcast characteristics of every country, say for example in Europe. Instead, tuner settings of car radios typically are only adapted to global continent preferences. Thus every single country in Europe, e.g. Italy, France, Germany, UK, Spain, Poland, etc. would only get the same global continent tuner settings, despite having quite different broadcast characteristics, some of which may give rise to the problems discussed above.

In view of the above-mentioned problems it is an object of the present disclosure to provide a method for increasing the performance of the FM reception of radio tuners, such as portable tuners or car radio tuners.

The above-mentioned is addressed by a method for setting different tuner and human machine interface, HMI, settings of a radio tuner with RDS functionality according to claim 1, as well as a corresponding radio tuner according to claim 9.

The disclosure provides a method for setting different tuner and human machine interface, HMI, settings of a radio tuner with RDS functionality comprising the steps of: evaluating the at least one RDS signal of a broadcast received by the radio tuner; determining current country and/or current region in accordance with the at least one RDS signal; adjusting tuner settings of the radio tuner in accordance with the determined current country and/or current region; andupdating the HMI settings of the radio tuner in accordance with the current country and/or current region.

Typically, the radio tuner is provided with a pre-stored default setting reflecting standard, global continent settings. Every single country and/or region gets the same global tuner settings for different broadcast transmitter characteristics. Country or regional tuner settings are known but are not respected in the default setting. However, the reception of the radio tuner may likely improve, if the tuner adjusts its parameters, e.g., its default settings to those known transmitter properties. A similar situation arises when the radio tuner or a device comprising the radio tuner relocates between countries or regions, respectively, e.g. a user using the portable device or a driver with the car moves to yet another country or back to a country of origin. There, again, a re-adjustment of tuner settings may likely improve the radio reception. The updating of the HMI settings of the radio tuner, e.g. presenting the user with a list of selectable programs, all of which carry a RDS signal, is closely connected with the adjusting or re-adjusting of the tuner settings. Thus the user may be provided with the most up to date list of programs or stations which may be receivable in the current region of the current country in which he/she uses the radio tuner. A dynamic loading of different tuner parameters, depending on the broadcast country and/or region, may cause a better FM reception, and/or may show different HMI settings, which in particular may depend on the grid.

The method may further comprise the step of providing a database of different predetermined tuner parameters stored in a storage unit comprised in the radio tuner.

Typically, experienced radio developers know which country uses which broadcast transmitting preferences. This information may become very detailed. Therefore, this information may be stored in a database. The database may be stored in a storage unit of the radio tuner. It may also be possible that the storage unit and the radio tuner together form a system or are part of an infotainment system or a portable system. The database may be pre-programmed.

The method may further comprise the step of loading specific tuner parameters from the database based on the evaluating step.

In the method adjusting tuner settings of the radio tuner may comprise adjusting tuner settings in accordance with the loaded specific tuner parameters.

The evaluating step may provide the result of the current country and current region. According to the result of the evaluation the respective specific tuner parameters may be searched in and loaded from the database. Then, the adjusting may utilize these specific tuner parameters for adjusting the tuner parameters which are used up until the adjusting step in order to improve the FM reception.

In the method determining the current country and/or current region may further comprise decoding the PI code and/or the Extended Country Code, ECC and determining the current country and/or current region from the decoded PI code and/or ECC.

The first most significant bits of the PI code carries the RDS country code. The four bit coding structure allows the definition of 15 different codes, 0x1 to 0xF. Thus, fifteen countries could be identified without sharing a common PI code. The ECC together with the PI code may render a unique combination. The ECC consists of eight bits. Full listings of the ECC and PI country/area codes are given for European countries in CENELEC EN 50067:1998, Annex D, and for the rest of the world in Annex N of the same document. One example may be that Spain, Sweden, and Romania all share the same PI code, namely E (E being a hexadecimal number). However, these countries may be distinguished by further using the ECC, e.g. Romania: E1, Spain: E2, and Sweden: E3. Therefore these countries may be uniquely identified by the PI code together with the ECC.

The method may further comprise that the PI code and/or the ECC are decoded from RDS group 1A. The PI code is transmitted in every group—however the ECC is transmitted by variant 0 of block 3 of type 1A group.

Information about the country which broadcasts the selected station may be found in the PI code and in the extended country code of RDS group 1A. This may allow that individual broadcast transmitter characteristics are considered by the receiver.

In the method adjusting tuner settings of the radio tuner may comprise adjusting concealment settings for the current country and/or current region.

The concealment settings refer to the strategies of concealment of reception errors when a reception of a broadcast becomes weak, such as switching from stereo to mono, using of filters etc. The concealment settings may be influenced by the quality of the signal received. A first concealment strategy may be to adjust or re-adjust tuner settings according to the current country and/or current region. This may include updating the current country and/or current region information evaluated from the RDS signal.

The method may further comprise updating the database with an amended set of different predetermined tuner parameters.

The database stored in the storage unit may be updatable. This may be done during a service update. Also, this may be done via an update signaled by the radio tuner or a system into which the radio tuner is integrated. It is understood that the user may trigger an update of the database. The database may also be updated by means of remote data transmission.

The disclosure also provides a radio tuner with RDS functionality, comprising: an evaluation unit configured to evaluate at least one RDS signal of a broadcast received by the radio tuner; a determining unit configured to determine current country and/or current region in accordance with the at least one RDS signal; an adjusting unit configured to adjust tuner settings of the radio tuner in accordance with the determined current country and/or current region; andan updating unit configured to update HMI settings of the radio tuner of the radio tuner in accordance with the determined current country and/or current region.

The advantages of the radio tuner with RDS functionality are the same as discussed for the corresponding method, above.

The radio tuner may further comprise a storage unit configured to store a database of different predetermined tuner parameters;

In the radio tuner the adjusting unit may be further configured to load specific tuner parameters from the database based on the evaluating step, and may be configured to adjust tuner settings in accordance with the loaded specific tuner parameters.

In the radio unit the determining unit may be further configured to decode the PI code and/or the Extended Country Code, ECC, and may be configured to determine the current country and/or current region from the decoded PI code and/or ECC.

In the radio tuner the determining unit may be configured to decode the PI code and/or the ECC from RDS group 1A.

The disclosure further provides an infotainment system installed in a vehicle, comprising a radio tuner as described above.

The disclosure further provides a portable device comprising a radio tuner as described above.

The radio tuner may be installed in a vehicle, either as a car radio or as a part of an infotainment system of the vehicle. Likewise, the radio tuner may be included into a portable device such as a mobile phone, smartphone or even a tablet computer.

Additional features and advantages of the present disclosure will be described with reference to the drawings. In the description, reference is made to the accompanying figures that are meant to illustrate example embodiments of the disclosure. It is understood that such embodiments do not represent the full scope of the disclosure.

### BRIEF DESCRIPTION OF THE DRAWINGS

FIGS. 1A and 1B illustrate a vehicle using an RDS radio tuner crossing a country or a regional border, according to an example of the present disclosure;

FIG. 2 shows a flow chart of the herein disclosed method for setting different tuner and human machine interface, HMI, settings of a radio tuner with RDS functionality;

FIG. 3 shows a further flow chart of the method of FIG. 2, however showing additional step of a further embodiment of the herein disclosed method for a method for setting different tuner and human machine interface, HMI, settings of a radio tuner with RDS functionality;

FIG. 4 shows a radio tuner with RDS functionality corresponding to the method as shown in FIGS. 2 and 3 according to the present disclosure;

FIG. 5A shows a portable device such as a smartphone including a radio tuner according to FIG. 4;

FIG. 5B shows a front part of a car, e.g., windscreen, steering wheel and a dashboard including an infotainment system including a radio tuner according to FIG. 4; and

FIG. 6 shows a block diagram of an example in-vehicle computing system.

### DETAILED DESCRIPTION

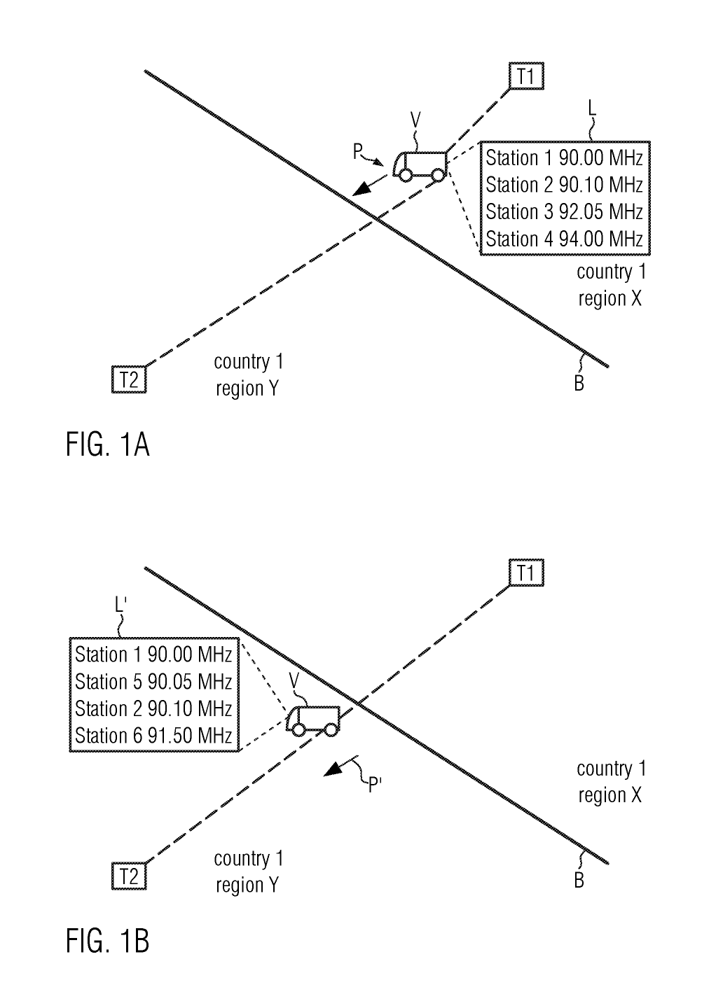

FIGS. 1A and 1B illustrate a vehicle using an RDS radio tuner crossing a country or a regional border, according to an example of the present disclosure. FIGS. 1A and 1B both show a vehicle V.

In FIG. 1A the vehicle V moves towards a regional border or a country border B in the direction of arrow P.

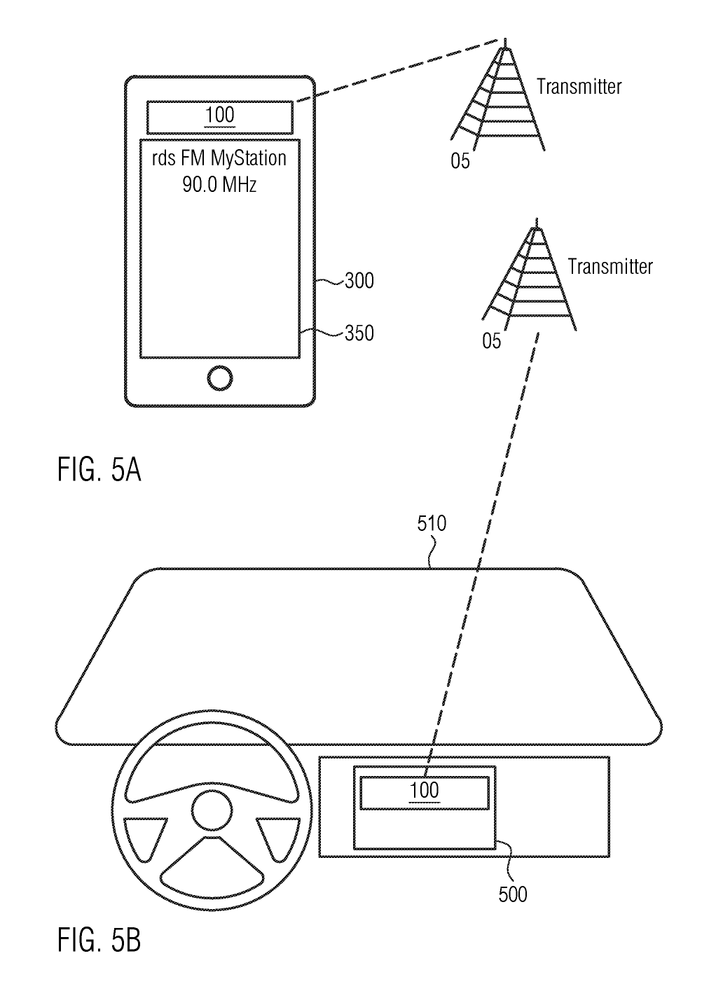

In FIG. 1B the vehicle is moving away for the border B in the direction of arrow P′. The vehicle V includes an RDS radio tuner. This may be radio tuner as included in an infotainment system, see FIG. 5B. In a zoomed in portion of FIGS. 1A part L of a display of the radio tuner of vehicle V is shown. In FIG. 1A part L displays four different stations which the driver of vehicle V may choose. Likewise, in FIG. 1B, part L′ displays four different stations. It should be understood that for the sake of legibility the number of stations displayed is four, but a different number of stations may be displayed. For the sake of example, these stations are denoted Station 1, Station 2, Station 3, and Station 3. The channel spacing of these stations in FIG. 1A is at least 100 kHz or more.

FIG. 1A further shows broadcast transmitter T1 located in country/region X broadcasting at least the programs Station 1, Station 2, Station 3, and Station 4. FIG. 1B shows transmitter T2 broadcasting at least the programs Station 1, Station 5, Station 2, and Station 6. It should be noted that in country/region Y the channel spacing between program Station 1 and program Station 2 is only 50 kHz, a value not present for the programs transmitted by transmitter T1 according to the transmitting preferences of country/region X. The adjusting of the RDS tuner settings resulting in the updated display of part L′ is explained in the following Figures.

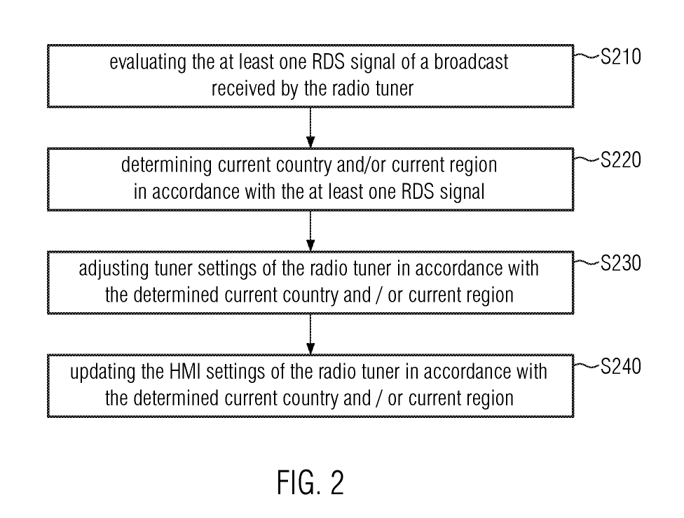

In FIG. 2 a flow chart illustrates the herein disclosed method for setting different tuner and human machine interface, HMI, settings of a radio tuner with RDS functionality.

In the flow chart as shown in FIG. 2, in step S210 the at least one RDS signal of a broadcast received by the radio tuner is evaluated. The RDS signal may be carried by at least one of the programs as exemplarily shown in FIG. 1. In step S220 the method proceeds with determining current country and/or current region in accordance with the at least one RDS signal received by the radio tuner. With regard to the exemplary scenario shown in FIG. 1, this will yield different result before and after crossing the country or regional border B in FIG. 1. This will also change again once the vehicle returns from country/region Y back to country/region X. Therefore, the radio tuner has available the broadcast transmitter settings of a country and/or region in which the radio tuner, for example in a vehicle, is currently positioned. In step S230 the method proceeds by adjusting the tuner settings of the radio tuner in accordance with the determined current country and/or current region. The current country and/or current region will be a token for the available broadcast transmitter settings to be used for the adjusting. Therefore, the tuner settings of the radio tuner may be properly adapted and adjusted. The method proceeds with step S240 by updating the HMI settings of the radio tuner in accordance with the current country and/or current region. Thus a list of station related information for the user of the radio tuner may be adapted to the present broadcast transmitter settings. In particular, the user may be able to choose stations/channels in accordance with the present broadcast transmitter settings which he could not have been offered with the previous or with standard settings.

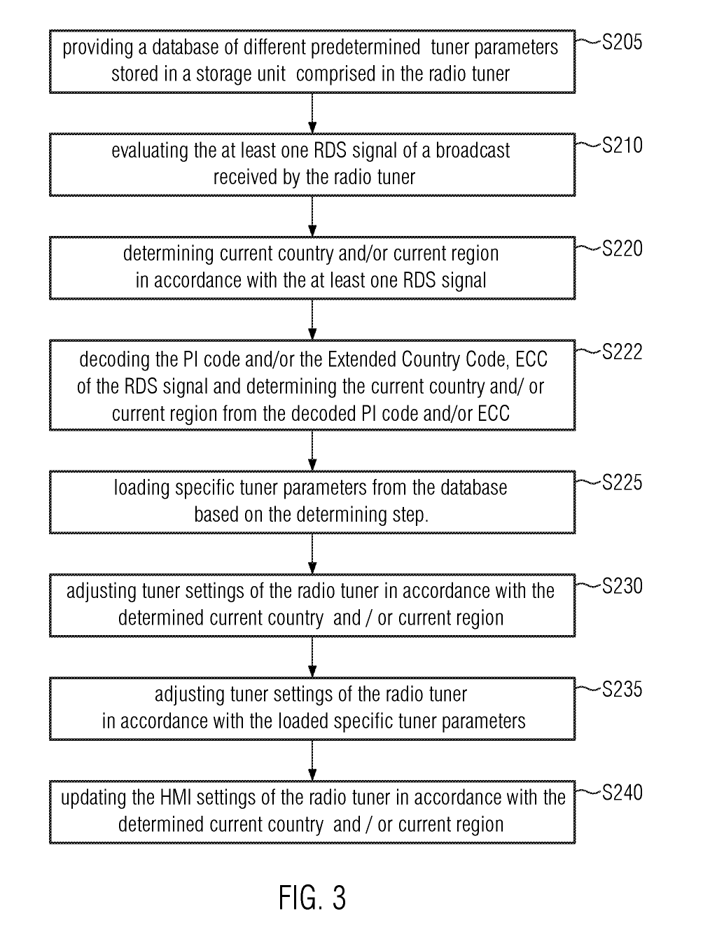

In FIG. 3 a flow chart illustrates the herein disclosed method for setting different tuner and human machine interface, HMI, settings of a radio tuner with RDS functionality. The flow chart of FIG. 3 corresponds to the flow chart of FIG. 2 but shows further steps and details. Steps of FIG. 3 which correspond to the steps of FIG. 2 are denoted with the same reference numbers and will not be explained, again. In step S205 it is shown that it is provided a database of different predetermined tuner parameters. These different predetermined tuner parameters are stored in a storage unit. The storage unit typically may be comprised in the radio tuner. With regard to the database of different predetermined tuner parameters, this may comprise all or at least all relevant broadcast transmitter preferences of countries in which the RDS radio tuner is to be used. In step S222 the current country and/or current region are determined by decoding the PI code and/or the Extended Country Code, ECC from the evaluated RDS signal and the determining the current country and/or current region from the decoded PI code and/or ECC. The radio tuner may interact with the database in that in step S225 specific tuner parameters are loaded from the database based on the evaluating step. In step S235 the tuner settings are adjusted in accordance with the loaded specific tuner parameters corresponding to the current country and/or current region as decoded and determined from the PI code and the ECC. The flow chart then concludes with step S240 as described with respect to FIG. 2.

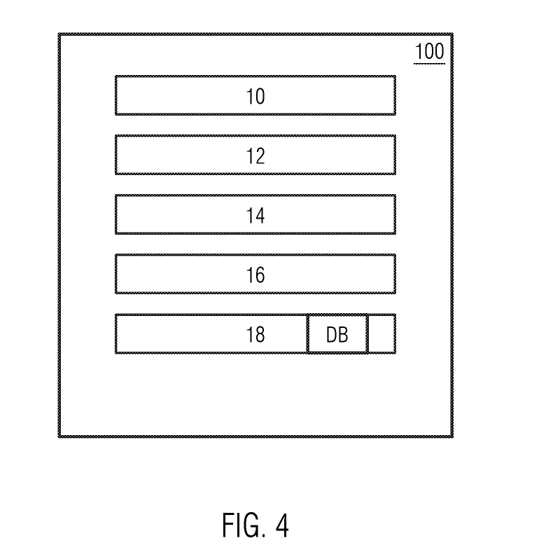

FIG. 4 schematically shows a radio tuner 100 with RDS functionality corresponding to the method as shown in FIGS. 2 and 3, according to the present disclosure. In particular, FIG. 4 shows that the radio tuner 100 comprises an evaluation unit 10. The evaluation unit 10 may be configured to evaluate at least one RDS signal of a broadcast received by the radio tuner 100. This RDS signal may be transmitted by a broadcast transmitter as depicted in FIG. 1 or in FIGS. 5A and 5B. The radio tuner 100 may further comprise a determining unit 12. The determining unit 12 may be configured to determine current country and/or current region in accordance with the at least one RDS signal. The radio tuner 100 further may comprise an adjusting unit 14. The adjusting unit may be configured to adjust tuner settings of the radio tuner 100 in accordance with the determined current country and/or current region. The radio tuner 100 may also comprise an updating unit 16 configured to update HMI settings of the radio tuner 100 in accordance with the determined current country and/or current region. Moreover, the radio tuner 100 may further comprise a storage unit 18. The storage unit 18 may be configured to store a database DB of different predetermined tuner parameters. The database DB is shown in FIG. 4 as being included, e.g., stored in the storage unit 18. It is understood that the determining unit 12, the adjusting unit 14, the updating unit 16, and the storage unit 18 may interact with each other, respectively. One or more of the determining unit 12, the adjusting unit 14, and the updating unit 16 may be either implemented as a physical or a logical unit of a processor. In particular, the adjusting unit 14 may be configured to load specific tuner parameters from the database DB based on the evaluating step. Subsequently, the adjusting unit 14 may be configured to adjust tuner settings in accordance with the loaded specific tuner parameters. The determining unit 12 may be configured to decode the PI code and/or the Extended Country Code, ECC and is configured to determine the current country and/or current region from the decoded PI code and/or ECC. In particular the determining unit 12 may be configured to decode the PI code and/or the ECC from RDS group 1A. Based on the result of the decoding, the adjusting of the tuner settings may be performed by the adjusting unit.

FIG. 5A shows a portable device such as a smartphone 300 including a radio tuner 100 according to FIG. 4. It should be understood that a smartphone is only one example for other portable device, such as handheld computers, tablets or the like, which are provided with an RDS radio tuner. In FIG. 4, the radio tuner 100 comprised in the smartphone 300 receives broadcast transmitted from transmitter 05. On the display 350 of the smartphone, either a list of available stations and/or a station presently tuned to is displayed. The list of available stations may change as shown in the example of FIG. 1.

Likewise, FIG. 5B shows a front part 510 of a car, e.g., windscreen, steering wheel and a dashboard including an infotainment system 500 including a radio tuner 100 according to FIG. 4. Similarly, as explained with regard to FIG. 1 and FIG. 5A, the infotainment system 500 may display a list of available stations and/or a station presently tuned to may be displayed. The list of available stations may vary as shown in the example of FIG. 1. In accordance with the present disclosure, the user may be offered improved FM reception by adjusting to the broadcast transmitter settings as discussed with regard to FIGS. 1-4.

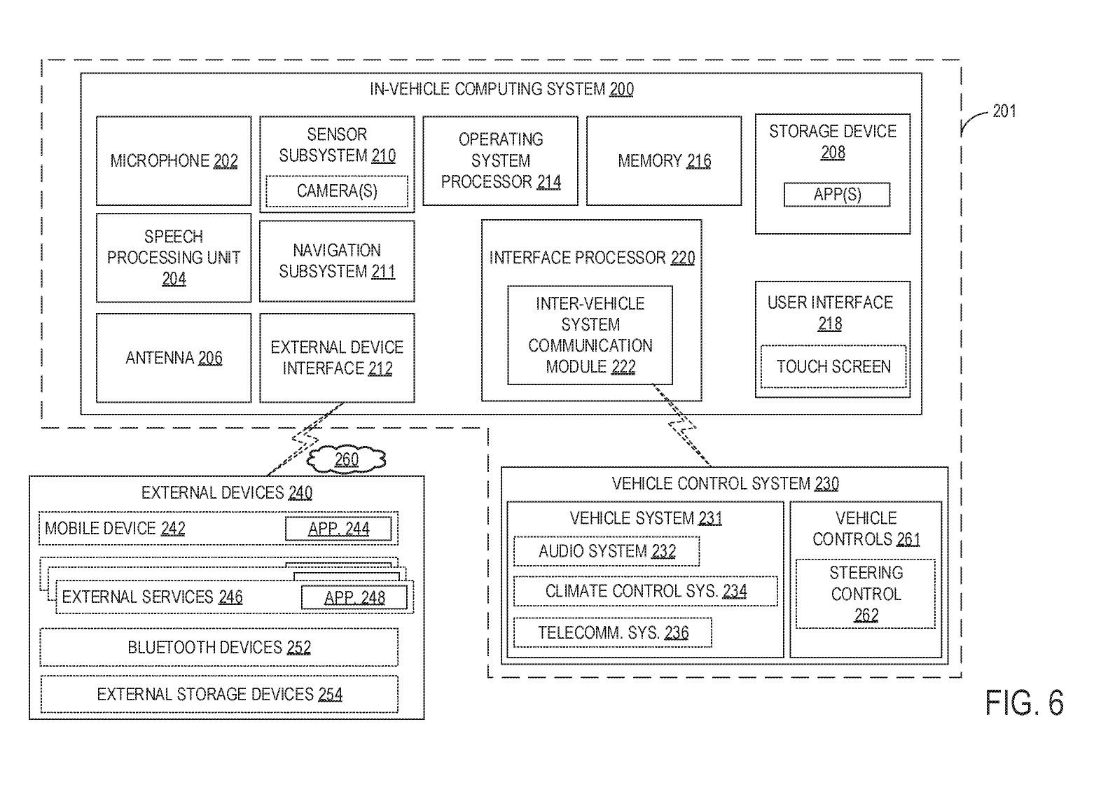

FIG. 6 shows a block diagram of an in-vehicle computing system 200 configured and/or integrated inside vehicle 201. In-vehicle computing system 200 may be an example of infotainment system 500 of FIG. 5B and/or may perform one or more of the methods described herein in some embodiments. In some examples, the in-vehicle computing system may be a vehicle infotainment system configured to provide information-based media content (audio and/or visual media content, including entertainment content, navigational services, etc.) to a vehicle user to enhance the operator's in-vehicle experience. The vehicle infotainment system may include, or be coupled to, various vehicle systems, sub-systems, hardware components, as well as software applications and systems that are integrated in, or integratable into, vehicle 201 in order to enhance an in-vehicle experience for a driver and/or a passenger.

In-vehicle computing system 200 may include one or more processors including an operating system processor 214 and an interface processor 220. Operating system processor 214 may execute an operating system on the in-vehicle computing system, and control input/output, display, playback, and other operations of the in-vehicle computing system. Interface processor 220 may interface with a vehicle control system 230 via an inter-vehicle system communication module 222.

Inter-vehicle system communication module 222 may output data to other vehicle systems 231 and vehicle control elements 261, while also receiving data input from other vehicle components and systems 231, 261, e.g. by way of vehicle control system 230. When outputting data, inter-vehicle system communication module 222 may provide a signal via a bus corresponding to any status of the vehicle, the vehicle surroundings, or the output of any other information source connected to the vehicle. Vehicle data outputs may include, for example, analog signals (such as current velocity), digital signals provided by individual information sources (such as clocks, thermometers, location sensors such as Global Positioning System [GPS] sensors, etc.), digital signals propagated through vehicle data networks (such as an engine controller area network [CAN] bus through which engine related information may be communicated, a climate control CAN bus through which climate control related information may be communicated, and a multimedia data network through which multimedia data is communicated between multimedia components in the vehicle). For example, the in-vehicle computing system may retrieve from the engine CAN bus the current speed of the vehicle estimated by the wheel sensors, a power state of the vehicle via a battery and/or power distribution system of the vehicle, an ignition state of the vehicle, etc. In addition, other interfacing means such as Ethernet may be used as well without departing from the scope of this disclosure.

A non-volatile storage device 208 may be included in in-vehicle computing system 200 to store data such as instructions executable by processors 214 and 220 in nonvolatile form. The storage device 208 may store application data to enable the in-vehicle computing system 200 to run an application for connecting to a cloud-based server and/or collecting information for transmission to the cloud-based server. The application may retrieve information gathered by vehicle systems/sensors, input devices (e.g., user interface 218), devices in communication with the in-vehicle computing system (e.g., a mobile device connected via a Bluetooth link), etc. In-vehicle computing system 200 may further include a volatile memory 216. Volatile memory 216 may be random access memory (RAM). Non-transitory storage devices, such as non-volatile storage device 208 and/or volatile memory 216, may store instructions and/or code that, when executed by a processor (e.g., operating system processor 214 and/or interface processor 220), controls the in-vehicle computing system 200 to perform one or more of the actions described in the disclosure.

A microphone 202 may be included in the in-vehicle computing system 200 to receive voice commands from a user, to measure ambient noise in the vehicle, to determine whether audio from speakers of the vehicle is tuned in accordance with an acoustic environment of the vehicle, etc. A speech processing unit 204 may process voice commands, such as the voice commands received from the microphone 202. In some embodiments, in-vehicle computing system 200 may also be able to receive voice commands and sample ambient vehicle noise using a microphone included in an audio system 232 of the vehicle.

One or more additional sensors may be included in a sensor subsystem 210 of the in-vehicle computing system 200. For example, the sensor subsystem 210 may include a camera, such as a rear view camera for assisting a user in parking the vehicle, a cabin camera for identifying a user (e.g., using facial recognition and/or user gestures), and/or a front view camera to assess quality of the route segment ahead. Sensor subsystem 210 of in-vehicle computing system 200 may communicate with and receive inputs from various vehicle sensors and may further receive user inputs. For example, the inputs received by sensor subsystem 210 may include transmission gear position, transmission clutch position, gas pedal input, brake input, transmission selector position, vehicle speed, engine speed, mass airflow through the engine, ambient temperature, intake air temperature, vehicle motion, vehicle inclination, etc., as well as inputs from climate control system sensors (such as heat transfer fluid temperature, antifreeze temperature, fan speed, passenger compartment temperature, desired passenger compartment temperature, ambient humidity, etc.), an audio sensor detecting voice commands issued by a user, a fob sensor receiving commands from and optionally tracking the geographic location/proximity of a fob of the vehicle, etc. While certain vehicle system sensors may communicate with sensor subsystem 210 alone, other sensors may communicate with both sensor subsystem 210 and vehicle control system 230, or may communicate with sensor subsystem 210 indirectly via vehicle control system 230. A navigation subsystem 211 of in-vehicle computing system 200 may generate and/or receive navigation information such as location information (e.g., via a GPS sensor and/or other sensors from sensor subsystem 210), route guidance, traffic information, point-of-interest (POI) identification, and/or provide other navigational services for the driver. The navigation subsystem 211 may include an inertial navigation system that may further determine a position, orientation, and velocity of the vehicle via motion and rotation sensor inputs. Examples of motion sensors include accelerometers, and examples of rotation sensors include gyroscopes. The navigation subsystem 211 may communicate with motion and rotation sensors included in the sensor subsystem 210. Alternatively, the navigation subsystem 211 may include motion and rotation sensors and determine the movement and rotation based on the output of these sensors.

External device interface 212 of in-vehicle computing system 200 may be coupleable to and/or communicate with one or more external devices 240 located external to vehicle 201. While the external devices are illustrated as being located external to vehicle 201, it is to be understood that they may be temporarily housed in vehicle 201, such as when the user is operating the external devices while operating vehicle 201. In other words, the external devices 240 are not integral to vehicle 201. The external devices 240 may include a mobile device 242 (e.g., connected via a Bluetooth, NFC, WIFI direct, or other wireless connection) or an alternate Bluetooth-enabled device 252. Mobile device 242 may be a mobile phone, smart phone, wearable devices/sensors that may communicate with the in-vehicle computing system via wired and/or wireless communication, or other portable electronic device(s). Other external devices include external services 246. For example, the external devices may include extra-vehicular devices that are separate from and located externally to the vehicle. Still other external devices include external storage devices 254, such as solid-state drives, pen drives, USB drives, etc. External devices 240 may communicate with in-vehicle computing system 200 either wirelessly or via connectors without departing from the scope of this disclosure. For example, external devices 240 may communicate with in-vehicle computing system 200 through the external device interface 212 over network 260, a universal serial bus (USB) connection, a direct wired connection, a direct wireless connection, and/or other communication link.

The external device interface 212 may provide a communication interface to enable the in-vehicle computing system to communicate with mobile devices associated with contacts of the driver. For example, the external device interface 212 may enable phone calls to be established and/or text messages (e.g., SMS, MMS, etc.) to be sent (e.g., via a cellular communications network) to a mobile device associated with a contact of the driver. The external device interface 212 may additionally or alternatively provide a wireless communication interface to enable the in-vehicle computing system to synchronize data with one or more devices in the vehicle (e.g., the driver's mobile device) via WIFI direct, as described in more detail below.

One or more applications 244 may be operable on mobile device 242. As an example, mobile device application 244 may be operated to aggregate user data regarding interactions of the user with the mobile device. For example, mobile device application 244 may aggregate data regarding music playlists listened to by the user on the mobile device, telephone call logs (including a frequency and duration of telephone calls accepted by the user), positional information including locations frequented by the user and an amount of time spent at each location, etc. The collected data may be transferred by application 244 to external device interface 212 over network 260. In addition, specific user data requests may be received at mobile device 242 from in-vehicle computing system 200 via the external device interface 212. The specific data requests may include requests for determining where the user is geographically located, an ambient noise level and/or music genre at the user's location, an ambient weather condition (temperature, humidity, etc.) at the user's location, etc. Mobile device application 244 may send control instructions to components (e.g., microphone, etc.) or other applications (e.g., navigational applications) of mobile device 242 to enable the requested data to be collected on the mobile device. Mobile device application 244 may then relay the collected information back to in-vehicle computing system 200.

Likewise, one or more applications 248 may be operable on external services 246. As an example, external services applications 248 may be operated to aggregate and/or analyze data from multiple data sources. For example, external services applications 248 may aggregate data from one or more social media accounts of the user, data from the in-vehicle computing system (e.g., sensor data, log files, user input, etc.), data from an internet query (e.g., weather data, POI data), etc. The collected data may be transmitted to another device and/or analyzed by the application to determine a context of the driver, vehicle, and environment and perform an action based on the context (e.g., requesting/sending data to other devices).

Vehicle control system 230 may include controls for controlling aspects of various vehicle systems 231 involved in different in-vehicle functions. These may include, for example, controlling aspects of vehicle audio system 232 for providing audio entertainment to the vehicle occupants, aspects of climate control system 234 for meeting the cabin cooling or heating needs of the vehicle occupants, as well as aspects of telecommunication system 236 for enabling vehicle occupants to establish telecommunication linkage with others.

Audio system 232 may include one or more acoustic reproduction devices including electromagnetic transducers such as speakers. Vehicle audio system 232 may be passive or active such as by including a power amplifier. In some examples, in-vehicle computing system 200 may be the only audio source for the acoustic reproduction device or there may be other audio sources that are connected to the audio reproduction system (e.g., external devices such as a mobile phone). The connection of any such external devices to the audio reproduction device may be analog, digital, or any combination of analog and digital technologies.

Climate control system 234 may be configured to provide a comfortable environment within the cabin or passenger compartment of vehicle 201. Climate control system 234 includes components enabling controlled ventilation such as air vents, a heater, an air conditioner, an integrated heater and air-conditioner system, etc. Other components linked to the heating and air-conditioning setup may include a windshield defrosting and defogging system capable of clearing the windshield and a ventilation-air filter for cleaning outside air that enters the passenger compartment through a fresh-air inlet.

Vehicle control system 230 may also include controls for adjusting the settings of various vehicle controls 261 (or vehicle system control elements) related to the engine and/or auxiliary elements within a cabin of the vehicle, such as steering wheel controls 262 (e.g., steering wheel-mounted audio system controls, cruise controls, windshield wiper controls, headlight controls, turn signal controls, etc.), instrument panel controls, microphone(s), accelerator/brake/clutch pedals, a gear shift, door/window controls positioned in a driver or passenger door, seat controls, cabin light controls, audio system controls, cabin temperature controls, etc. Vehicle controls 261 may also include internal engine and vehicle operation controls (e.g., engine controller module, actuators, valves, etc.) that are configured to receive instructions via the CAN bus of the vehicle to change operation of one or more of the engine, exhaust system, transmission, and/or other vehicle system. The control signals may also control audio output at one or more speakers of the vehicle's audio system 232. For example, the control signals may adjust audio output characteristics such as volume, equalization, audio image (e.g., the configuration of the audio signals to produce audio output that appears to a user to originate from one or more defined locations), audio distribution among a plurality of speakers, etc. Likewise, the control signals may control vents, air conditioner, and/or heater of climate control system 234. For example, the control signals may increase delivery of cooled air to a specific section of the cabin.

Control elements positioned on an outside of a vehicle (e.g., controls for a security system) may also be connected to computing system 200, such as via communication module 222. The control elements of the vehicle control system may be physically and permanently positioned on and/or in the vehicle for receiving user input. In addition to receiving control instructions from in-vehicle computing system 200, vehicle control system 230 may also receive input from one or more external devices 240 operated by the user, such as from mobile device 242. This allows aspects of vehicle systems 231 and vehicle controls 261 to be controlled based on user input received from the external devices 240.

In-vehicle computing system 200 may further include an antenna 206. Antenna 206 is shown as a single antenna, but may comprise one or more antennas in some embodiments. The in-vehicle computing system may obtain broadband wireless internet access via antenna 206, and may further receive broadcast signals such as radio, television, weather, traffic, and the like. The in-vehicle computing system may receive positioning signals such as GPS signals via one or more antennas 206. The in-vehicle computing system may also receive wireless commands via RF such as via antenna(s) 206 or via infrared or other means through appropriate receiving devices. In some embodiments, antenna 206 may be included as part of audio system 232 or telecommunication system 236. Additionally, antenna 206 may provide AM/FM radio signals to external devices 240 (such as to mobile device 242) via external device interface 212.

One or more elements of the in-vehicle computing system 200 may be controlled by a user via user interface 218. User interface 218 may include a graphical user interface presented on a touch screen and/or user-actuated buttons, switches, knobs, dials, sliders, etc. For example, user-actuated elements may include steering wheel controls, door and/or window controls, instrument panel controls, audio system settings, climate control system settings, route/route segment quality preference, route/route segment avoidance preference, and the like. A user may also interact with one or more applications of the in-vehicle computing system 200 and mobile device 242 via user interface 218. In addition to receiving a user's vehicle setting preferences on user interface 218, vehicle settings selected by in-vehicle control system may be displayed to a user on user interface 218. Notifications and other messages (e.g., received messages), as well as navigational assistance, may be displayed to the user on a display of the user interface. User preferences/information and/or responses to presented messages may be performed via user input to the user interface.

All previously discussed embodiments are not intended as limitations but serve as examples illustrating features and advantages of the disclosure. It is to be understood that some or all of the above described features can also be combined in different ways.

The systems and methods described above also provide for a method for setting different tuner and human machine interface, HMI, settings of a radio tuner with RDS functionality, comprising the steps of evaluating the at least one RDS signal of a broadcast received by the radio tuner, determining current country and/or current region in accordance with the at least one RDS signal, adjusting tuner settings of the radio tuner in accordance with the determined current country and/or current region, and updating the HMI settings of the radio tuner in accordance with the current country and/or current region. In a first example of the method, the method may further comprise providing a database of different predetermined tuner parameters stored in a storage unit comprised in the radio tuner. A second example of the method optionally includes the first example and further includes the method further comprising loading specific tuner parameters from the database based on the evaluating. A third example of the method optionally includes any one or both of the first example and the second example, and further includes the method wherein adjusting tuner settings of the radio tuner comprises adjusting tuner settings in accordance with the loaded specific tuner parameters. A fourth example of the method optionally includes any one or more of the first through the third examples, and further includes the method wherein determining the current country and/or current region comprises decoding the PI code and/or the Extended Country Code, ECC and determining the current country and/or current region from the decoded PI code and/or ECC. A fifth example of the method optionally includes any one or more of the first through the fourth examples, and further includes the method wherein the PI code and/or the ECC are decoded from RDS group 1A. A sixth example optionally includes any one or more of the first through the fifth examples, and further includes the method wherein adjusting tuner settings of the radio tuner comprises adjusting concealment settings for the current country and/or current region. A seventh example optionally includes any one or more of the first through the sixth examples, and further includes the method further comprising updating the database with an amended set of different predetermined tuner parameters.

The systems and methods described above also provide for a radio tuner with RDS functionality, the radio tuner comprising: an evaluation unit configured to evaluate at least one RDS signal of a broadcast received by the radio tuner; a determining unit configured to determine current country and/or current region in accordance with the at least one RDS signal; an adjusting unit configured to adjust tuner settings of the radio tuner in ac-cordance with the determined current country and/or current region; and an updating unit configured to update HMI settings of the radio tuner in accordance with the determined current country and/or current region. A first example of the radio tuner includes the radio tuner further comprising a storage unit configured to store a database of different predetermined tuner parameters. A second example of the radio tuner optionally includes the first example and further includes the radio tuner wherein the adjusting unit is further configured to load specific tuner parameters from the database based on the evaluating step, and is configured to adjust tuner settings in accordance with the loaded specific tuner parameters. A third example of the radio tuner optionally includes any one or both of the first example and the second example, and further includes the radio tuner wherein the determining unit is further configured to decode the PI code and/or the Extended Country Code, ECC and is configured to determine the current country and/or current region from the decoded PI code and/or ECC. A fourth example of the radio tuner optionally includes any one or more of the first example through the third example, and further includes the radio tuner wherein the determining unit is configured to decode the PI code and/or the ECC from RDS group 1A. A fifth example of the radio tuner optionally includes any one or more of the first example through the fourth example, and further includes the radio tuner wherein the radio tuner is installed in a portable device.

The systems and methods described above also provide for an infotainment system installed in a vehicle, the infotainment system including a radio tuner with RDS functionality, the radio tuner including: an evaluation unit configured to evaluate at least one RDS signal of a broadcast received by the radio tuner, a determining unit configured to determine current country and/or current region in accordance with the at least one RDS signal, an adjusting unit configured to adjust tuner settings of the radio tuner in accordance with the determined current country and/or current region, and an updating unit configured to update HMI settings of the radio tuner in accordance with the determined current country and/or current region. In a first example of the infotainment system, the infotainment system further comprises a storage unit configured to store a database of different predetermined tuner parameters. A second example of the infotainment system optionally includes the first example, and further includes the infotainment system wherein the adjusting unit is further configured to load specific tuner parameters from the database based on the evaluating. A third example of the infotainment system optionally includes any one or both of the first example and the second example and further includes the infotainment system wherein the adjusting unit is further configured to adjust tuner settings in accordance with the loaded specific tuner parameters. A fourth example of the infotainment system optionally includes any one or more of the first example through the third example, and further includes the infotainment system wherein the determining unit is further configured to decode the PI code and/or the Extended Country Code, ECC and is configured to determine the current country and/or current region from the decoded PI code and/or ECC. A fifth example of the infotainment system optionally includes any one or more of the first example through the fourth example, and further includes the infotainment system wherein the determining unit is configured to decode the PI code and/or the ECC from RDS group 1A.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as the in-vehicle computing system 200 described with reference to FIG. 6 infotainment system 500 described with reference to FIG. 5B. The methods may be performed by executing stored instructions with one or more logic devices (e.g., processors) in combination with one or more additional hardware elements, such as storage devices, memory, hardware network interfaces/antennas, switches, actuators, clock circuits, etc. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

1. A method for setting different tuner and human machine interface, HMI, settings of a radio tuner with RDS functionality, the method comprising:
evaluating the at least one RDS signal of a broadcast received by the radio tuner;
determining current country and/or current region in accordance with the at least one RDS signal;
adjusting tuner settings of the radio tuner in accordance with the determined current country and/or current region; and
updating the HMI settings of the radio tuner in accordance with the current country and/or current region.

2. The method according to claim 1, further comprising providing a database of different predetermined tuner parameters stored in a storage unit comprised in the radio tuner.

3. The method according to claim 2, further comprising loading specific tuner parameters from the database based on the evaluating.

4. The method according to claim 3, wherein adjusting tuner settings of the radio tuner comprises adjusting tuner settings in accordance with the loaded specific tuner parameters.

5. The method according to claim 1, wherein determining the current country and/or current region comprises decoding the PI code and/or the Extended Country Code, ECC and determining the current country and/or current region from the decoded PI code and/or ECC.

6. The method according to claim 5, wherein the PI code and/or the ECC are decoded from RDS group 1A.

7. The method according to claim 1, wherein adjusting tuner settings of the radio tuner comprises adjusting concealment settings for the current country and/or current region.

8. The method according to claim 2, further comprising updating the database with an amended set of different predetermined tuner parameters.

9. A radio tuner with RDS functionality, the radio tuner comprising:
an evaluation unit configured to evaluate at least one RDS signal of a broadcast received by the radio tuner;
a determining unit configured to determine current country and/or current region in accordance with the at least one RDS signal;
an adjusting unit configured to adjust tuner settings of the radio tuner in accordance with the determined current country and/or current region; and
an updating unit configured to update HMI settings of the radio tuner in accordance with the determined current country and/or current region.

10. The radio tuner according to claim 9, further comprising a storage unit configured to store a database of different predetermined tuner parameters.

11. The radio tuner according to claim 10, wherein the adjusting unit is further configured to load specific tuner parameters from the database based on the evaluating, and is configured to adjust tuner settings in accordance with the loaded specific tuner parameters.

12. The radio tuner according to claim 9, wherein the determining unit is further configured to decode the PI code and/or the Extended Country Code, ECC and is configured to determine the current country and/or current region from the decoded PI code and/or ECC.

13. The radio tuner according to claim 12, wherein the determining unit is configured to decode the PI code and/or the ECC from RDS group 1A.

14. The radio tuner according to claim 9, wherein the radio tuner is installed in a portable device.

15. An infotainment system installed in a vehicle, the infotainment system comprising:
a radio tuner with RDS functionality, the radio tuner comprising:
an evaluation unit configured to evaluate at least one RDS signal of a broadcast received by the radio tuner;
a determining unit configured to determine current country and/or current region in accordance with the at least one RDS signal;
an adjusting unit configured to adjust tuner settings of the radio tuner in accordance with the determined current country and/or current region; and
an updating unit configured to update HMI settings of the radio tuner in accordance with the determined current country and/or current region.

16. The infotainment system of claim 15, further comprising a storage unit configured to store a database of different predetermined tuner parameters.

17. The infotainment system of claim 16, wherein the adjusting unit is further configured to load specific tuner parameters from the database based on the evaluating.

18. The infotainment system of claim 17, wherein the adjusting unit is further configured to adjust tuner settings in accordance with the loaded specific tuner parameters.

19. The infotainment system of claim 15, wherein the determining unit is further configured to decode the PI code and/or the Extended Country Code, ECC and is configured to determine the current country and/or current region from the decoded PI code and/or ECC.

20. The infotainment system of claim 19, wherein the determining unit is configured to decode the PI code and/or the ECC from RDS group 1A.
